(19) United States
(12) Patent Application Publication
(10) Pub. No.: US 2007/0140255 A1
(43) Pub. Date: Jun. 21, 2007

(54) Method and system for communication across different wireless technologies using a multimode mobile device

(75) Inventors: Roberto Gautier, Davie, FL (US); James R. Wise, Monroe, NC (US); Jason T. Young, Palm City, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/313,424

(22) Filed: Dec. 21, 2005

(51) Int. Cl. H04L 12/56

(52) U.S. Cl. 370/395.5

(57) ABSTRACT

A mobile wireless device (302) can include a first processor (614) for establishing a first communication link using a first wireless communication protocol, a second processor (615) for establishing a second communication link using a second wireless communication protocol different from the first wireless communication protocol, and an interprocessor communication link (620) between the first processor and the second processor enabling communication between the first communication link and the second communication link. The mobile wireless device can serve as a dispatcher coupling a first mobile radio 112 using the first wireless communication protocol with a second mobile radio 116 using the second wireless communication protocol. The first wireless communication protocol can be a cellular communication protocol and the second wireless communication protocol can be a dispatch radio communication protocol. The first wireless communication protocol and the second wireless communication protocol can also utilize a wireline communication link (104).

### FIELD OF THE DISCLOSURE

The present disclosure relates generally to communication systems and networks, and more specifically to a method and system for linking different communication channels using a multimode mobile device.

### BACKGROUND

For multimode devices using multiple wireless network technologies, the common link between such wireless network technologies is typically a public telephone switch. End users with multimode communication devices such as a cellular phone with dispatch service (such as Motorola's i850 phone) can communicate with third parties on either access technology separately, but cannot concurrently communicate using both technologies. Consequently, an end user with a multimode communication device cannot engage in a three-way party conference with one party carrying a dispatch radio, and another carrying a cellular phone. Nor can the multimode communication device serve as a dispatch or intermediary among wireless devices using different wireless technologies.

### SUMMARY OF THE DISCLOSURE

Embodiments in accordance with the disclosure provide a system and method for communication across different wireless technologies using a multimode mobile device.

In a first embodiment of the present disclosure, a mobile wireless subscriber radio can include a first processor for establishing a first communication link using a first wireless communication protocol, a second processor for establishing a second communication link using a second wireless communication protocol different from the first wireless communication protocol, and an interprocessor communication link between the first processor and the second processor enabling communication between the first communication link and the second communication link. The mobile wireless subscriber radio can serve as a dispatcher coupling a first mobile radio using the first wireless communication protocol with a second mobile radio using the second wireless communication protocol. The first wireless communication protocol can be a cellular communication protocol and the second wireless communication protocol can be a dispatch radio communication protocol. Alternatively, the first wireless communication protocol can be a cellular communication protocol or a dispatch radio communication protocol and the second wireless communication protocol can be a peer-to-peer communication protocol or a talk-around communication protocol or a point-to-point communication protocol. The first wireless communication protocol can be a Push-to-Talk over cellular (PoC) communication protocol and the second wireless communication protocol can be a dispatch radio Push-to-Talk (PTT) communication protocol. The first wireless communication protocol and the second wireless communication protocol can also utilize a wireline communication link.

In yet another alternative, the first wireless communication protocol can be a cellular communication protocol, the second wireless communication protocol can be a dispatch radio communication protocol and a third wireless communication protocol can be a peer-to-peer communication protocol or a talk-around communication protocol or a point-to-point communication protocol. In such an instance, the mobile wireless subscriber radio can further include a third processor for establishing a third communication link using the third wireless communication protocol, where the interprocessor communication link further links the third processor with the first processor and the second processor and enables communication among such processors. The mobile wireless subscriber radio can also serve as a dispatcher for a third mobile radio using the third wireless communication protocol and coupling the third mobile radio with a first mobile radio using the first wireless communication protocol and with a second mobile radio using the second wireless communication protocol.

In a second embodiment of the present disclosure, a system for communication across different wireless communication technologies can include a first base station using a first wireless communication protocol, at least a second base station using a second wireless communication protocol different from the first wireless communication protocol, and a multimode wireless mobile device. The multimode wireless mobile device can include a first processor for establishing a first communication link using the first wireless communication protocol, at least a second processor for establishing a second communication link using the second wireless communication protocol, and an interprocessor communication link between the first processor and the second processor enabling communication between a first wireless device on the first communication link and a second wireless device on the second communication link. The multimode wireless mobile device can serve as a dispatcher coupling the first wireless device using the first wireless communication protocol with the second wireless device using the second wireless communication protocol. The first wireless communication protocol can be a cellular communication protocol or a dispatch radio communication protocol and the second wireless communication protocol can be a dispatch radio communication protocol. The second wireless communication protocol can alternatively be a peer-to-peer communication protocol or a talk-around communication protocol or a point-to-point communication protocol. The first wireless communication protocol can be a Push-to-Talk over cellular communication protocol and the second wireless communication protocol can be a dispatch radio Push-to-Talk communication protocol. The first wireless communication protocol and the second wireless communication protocol can further utilize a wireline communication link.

In one alternative of the system, the first wireless communication protocol can be a cellular communication protocol, the second wireless communication protocol can be a dispatch radio communication protocol and a third wireless communication protocol can be a peer-to-peer communication protocol or a talk-around communication protocol or a point-to-point communication protocol. In such an instance, the multimode wireless mobile device can further include a third processor for establishing a third communication link using the third wireless communication protocol and the multimode wireless mobile device can serve as a dispatcher for a third mobile radio using the third wireless communication protocol and coupling the third mobile radio with the first wireless device using the first wireless communication protocol and with the second wireless device using the second wireless communication protocol.

In a third embodiment of the present disclosure, a mobile wireless subscriber radio can include a first processor for establishing a first communication link using a first wireless communication protocol, a second processor for establishing a second communication link using a second wireless communication protocol different from the first wireless communication protocol, a third processor for establishing a third communication link using a third wireless communication protocol different from the first and second wireless communication protocols, and an interprocessor communication link between the first processor, the second processor, and the third processor enabling communication among the first communication link, the second communication link, and the third communication link. The mobile wireless subscriber radio can serve as a dispatcher for a third mobile radio using the third wireless communication protocol and coupling the third mobile radio with the first wireless device using the first wireless communication protocol and with the second wireless device using the second wireless communication protocol.

### BRIEF DESCRIPTION OF THE DRAWINGS

FIG. 1 is a block diagram of existing wireless communications linked only by a wired switch (PSTN).

FIG. 2 is a block diagram of a multimode device linking mobile devices from different networks and from an off-network device according to teachings of the present disclosure.

FIG. 3 is a block diagram of a multimode device serving as a dispatcher among two mobile devices operating on two different wireless technologies according to teachings of the present disclosure.

FIG. 4 is a block diagram of a multimode device enabling communication among an off-network device, and two different mobile devices operating on two different wireless technologies according to teachings of the present disclosure.

FIG. 5 is a block diagram of a multimode device enabling concurrent communication on two different wireless networks using different wireless technologies according to teachings of the present disclosure.

FIG. 6 is a block diagram of a multimode wireless device according to teachings of the present disclosure.

FIG. 7 is a flow chart of a method of operating a multimode wireless device in accordance with the teachings of the present disclosure.

### DETAILED DESCRIPTION

On a mobile device network, a mobile unit must be within the network's coverage in order to be accessible. Mobile users could contact each other as long as they are within the network coverage and within the same network. In a system 100 of FIG. 1, a first cellular base station or stations 118 can form a cell 110 in communication with a first wireless infrastructure 106 such as Motorola's iDEN wireless network equipment. A plurality of mobile subscriber units 116 can communicate the base station(s) 118. A second wireless network can include a second cellular base station or stations 114 forming a cell 108 in communication with a second wireless infrastructure 102 such as CDMA fixed network equipment. A plurality of mobile subscriber units 112 can communicate with the base station(s) 114. The cells 108 and 110 each use different wireless technologies (CDMA, TDMA, iDEN, etc.). If a mobile subscriber using the first wireless infrastructure (106) wants to communicate with a mobile subscriber using the second wireless infrastructure (102) of a different network, then the network can use the Public Telephone Switching Network (PSTN 104) to connect both networks, which becomes the link between both networks.

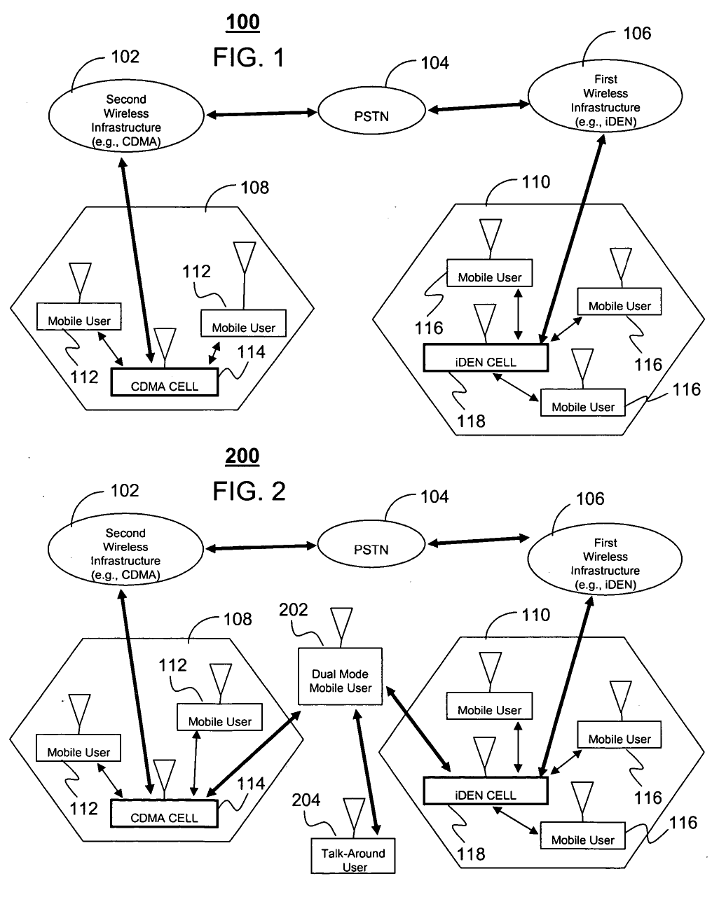

Embodiments herein can implement a link between networks using a mobile subscriber or wireless handset instead of expensive network equipment such as the PSTN 104. Referring to FIG. 2, a similar system 200 to system 100 of FIG. 1 is illustrated further including a multimode mobile subscriber 202 that links the two cells (102 and 106) of different wireless technology. Since there can be processors in the multimode mobile subscriber device 202 to maintain links on each network, the network activity (data or voice) on one network can be routed from processor to processor via an inter-processor communication link in the multimode mobile subscriber device 202 and routed to the users of different networks. The communication link can utilize dual port RAM to form the inter-processor link. Thus, in the system 200, a mobile device 116 using a first wireless technology can communicate with a mobile device 112 using a second wireless technology via either the traditional PSTN 104 or the wireless link provided by the multimode mobile subscriber device 202. The common link between these networks is the PSTN and the multimode user. In a particular system having an iDEN system with dispatch service on one network and CDMA cellular service on a second network, a Dual Mode user can serve as the link to connect the CDMA network to the dispatch only users. It should be noted that an equivalent embodiment as contemplated in the claimed scope herein can include a single processor or even a portion of a single processor (as opposed to multiple processors) that can process two or more wireless technologies and can include internal links that essentially serves as the inter-processor link or more appropriately an intra-processor link (for a single processor) handling the different wireless protocols.

The dual mode user can also link to other users using other protocols supported (like MotoTalk) that can connect to the Dual Mode user. In this regard, the multimode mobile subscriber device 202 can also communicate with a non-networked device 204. Note, the non-networked device does not necessarily need to be within range of the either cell, but does need to be within communication range of the multimode mobile subscriber device 202.

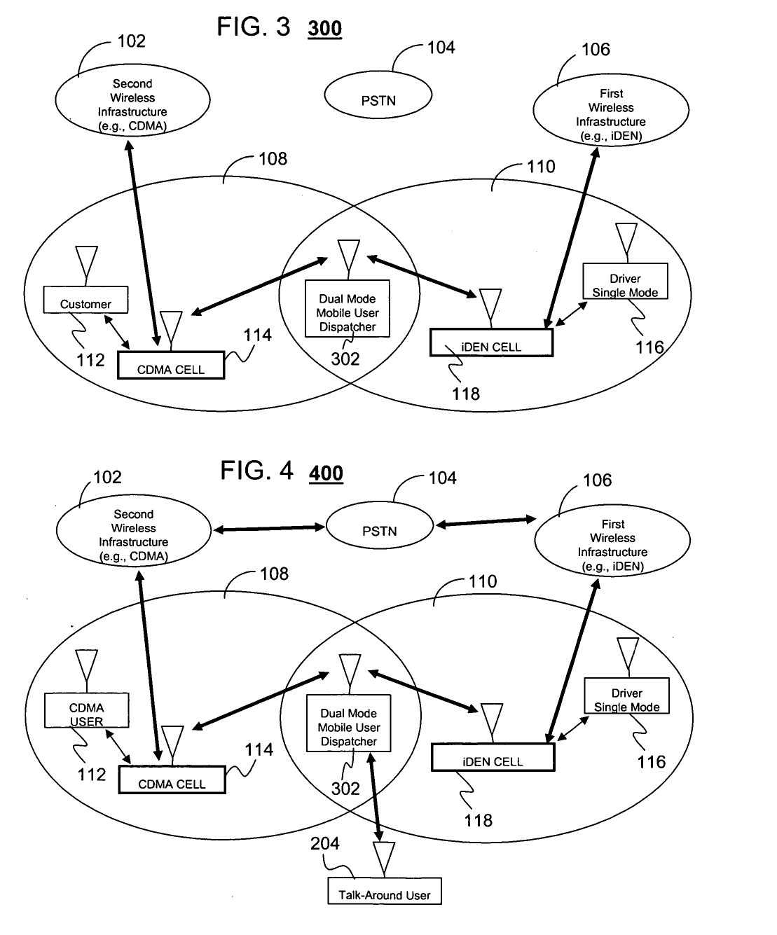

Referring to FIG. 3, a system 300 similar to FIG. 200 is illustrated where no link exists between the first wireless infrastructure 106 and the second wireless infrastructure 102 via the PSTN 104. In this example, a wireless subscriber 112 on the second wireless system can be a customer using CDMA trying to deliver a message to another mobile subscriber 116 such as a driver using another wireless technology such as dispatch radio or PTT technology. If the wireless subscriber 112 otherwise has no access to the driver using PTT technology (116), the customer can call a mobile dispatcher who is using a multimode mode phone 302 and have a direct link to the driver to give delivery directions.

Referring to FIG. 4, a system 400 similar to system 200 of FIG. 2 is illustrated. The system 400 enables either a wireless subscriber 112 using only CDMA technology for example or a subscriber 116 using another wireless technology (different from that used by 112) to communicate with yet a third technology-based wireless device 204. The wireless device 204 can use a talk-around protocol, or MotoTalk by Motorola or more generically known as a wireless peer-to-peer protocol that does not require infrastructure equipment. The wireless subscriber 112 or 116 can call the multimode wireless device 302 serving as a dispatch device to link the subscriber device 112 or 116 to the wireless device 204. Likewise, the talk-around device 204 can contact the multimode wireless device 302 to contact either wireless subscriber device 112 or 116.

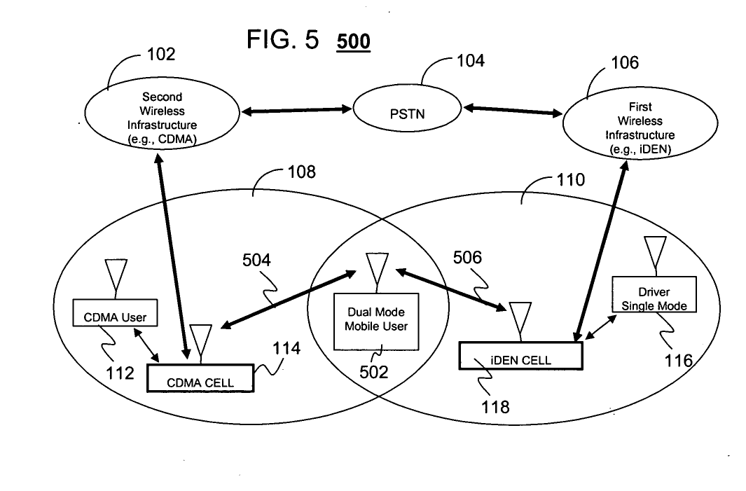

In another scenario referring to the system 500 of FIG. 5, a dual mode or multimode wireless device 502 can down load data on link 504 while also having a dispatch call at the same time on link 506. The user of the dual mode wireless device 502 not miss a incoming call despite being on a dispatch call or receiving data.

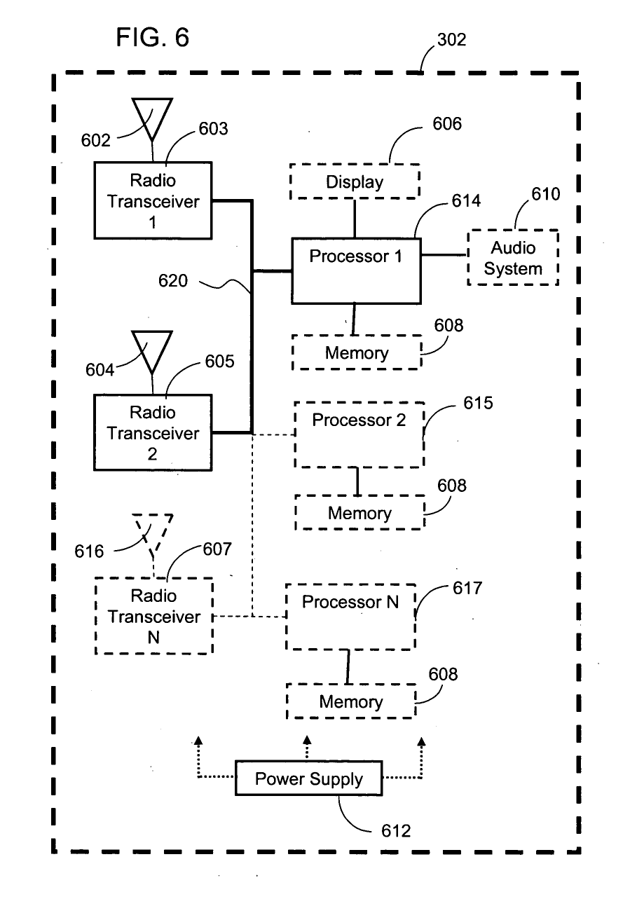

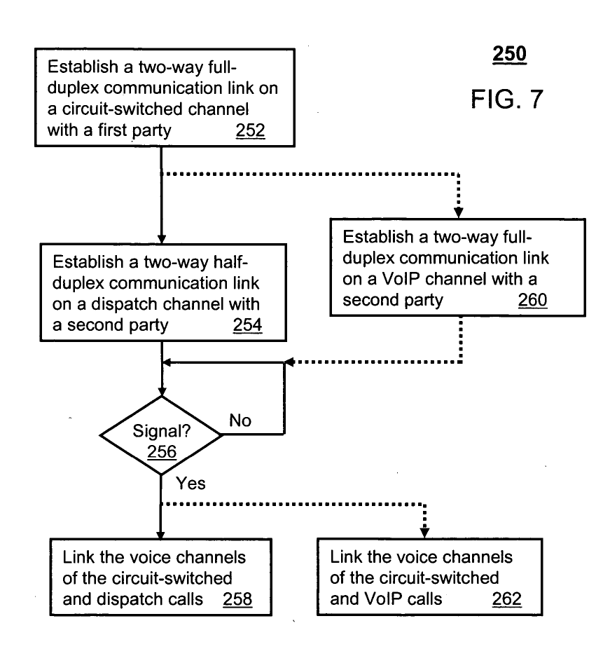

Referring to FIG. 6, the wireless device 302 such a multi-mode radio in a communication systems 300 or 400 shown in FIGS. 3 and 4 respectively can be implemented in the form of a cellular phone, a lap top computer or a camera phone or any other electronic device having one or more transceivers 603, 605 or 607 having corresponding antennas 602, 604, or 616 and corresponding processors 614, 615, or 617. The electronic device can further include a display 606 for conveying images to a user of the device, a memory 608 including one or more storage elements (e.g., Static Random Access Memory, Dynamic RAM, Read Only Memory, etc.), an optional audio system 610 for conveying audible signals (e.g., voice messages, music, etc.) to the user of the device, a power supply 612 for powering the components of the device, and the processor(s) (614, 615, or 617) comprising one or more conventional microprocessors and/or digital signal processors (DSPs) for controlling operations of the foregoing components.

The wireless device 302 can use the first processor 603 for establishing a first communication link using a first wireless communication protocol, a second processor 605 for establishing a second communication link using a second wireless communication protocol different from the first wireless communication protocol, and a third processor 617 for establishing a third communication link using a third wireless communication protocol different from the first and second wireless communication protocols. For example, the first transceiver 603 can be an iDEN transceiver, the second transceiver 605 can be a CDMA EVDO transceiver, and the third transceiver 607 can be used for talk-around mode or family radio service (FRS) radio. The wireless device can further include an inter-processor communication link 620 between the first processor, the second processor, and the third processor enabling communication among the first communication link, the second communication link, and the third communication link. The mobile wireless subscriber radio 302 can serve as a dispatcher for a third mobile radio using the third wireless communication protocol (such as talk-around mode) and coupling a third mobile radio (204 in FIG. 4) with the first wireless device (116) using the first wireless communication protocol and with the second wireless device (112) using the second wireless communication protocol. The multimode wireless device 302 can utilize wireless or wireline technology for communicating with a communication system with two or more disparate access technologies. In the case of wireless communications, the device 302 can operate in any number of communication systems that support, for example, two-way full-duplex voice and data communications such as with cellular technology (CDMA 1X, EV/DO, GSM, GPRS, Edge), WiFi, WiMax, and Bluetooth™. Additionally, the multimode wireless device 302 can support two-way half-duplex voice technologies such as dispatch radio services operating under licensed frequencies, or Family Radio Services (FRS) operating under public frequencies. In the case of wireline communications, the multimode wireless device 302 can include technology that supports, for example, POTS (Plain Old Telephone Service), ISDN, Ethernet, Voice over IP (VoIP), and so on.

With this in mind, a method 250 begins with step 262 where a processor such as processor 615 establishes a two-way full-duplex communication link on a circuit-switched channel of a communication system (herein referred to by way of example as a CDMA network) with a first communication device (112) in response to an end user of a wireless device, for example, dialing a phone number on a keypad. The two-way full-duplex communication link can operate on a circuit-switched channel of the CDMA network, thereby providing the end user or the first party a means to exchange simultaneous voice messages by way of the audio system 610 (of FIG. 6).

In step 654, a processor 614 (of FIG. 6) can establish a two-way half-duplex communication link on a dispatch channel with a second party. This step can be invoked by the end user of the CDMA device 112 or the dual mode device (302) for example who desires to conference the second party with the first party even though both parties have disparate access technologies (i.e., dispatch half-duplex voice services with the second party, and full-duplex circuit-switched voice services with the first party). The end user of the dual mode device 302 in this step can place the first party on hold while attempting to make a dispatch call on the dispatch service mode of the dual mode device 302 by way of, for example, a push-to-talk (PTT).

Once the second party has been contacted, the end user (of the dual mode or multimode device 302) can conference or can serve as the dispatcher for the second party with the first party by depressing continuously a PTT button for example to initiate a conference signal that is detected by the processors in step 256. In response to this signal, the processors proceed to step 258 where it links the voice channels of the circuit-switched and dispatch calls, thereby connecting the second caller to the communication already established between the end user and the first caller. This step can be accomplished by the processors by linking voice channels in the protocols stacks of each access technology operating in the multimode or dual mode wireless device 302 without assistance from infrastructure equipment of a communication system supporting circuit-switched and dispatch services. Alternatively, the PTT signal can be detected by infrastructure equipment of the communication system, and in response thereto perform linking of voice channels of each of the circuit-switched and dispatch access technologies.

Once the linking process is completed, the second caller can listen to what is said between the first caller (112) and the end user (302). Similarly, the second caller (116) can submit voice responses which can be heard by the end user (302) and/or the first caller (112) after the second party depresses the PTT button of his or her dispatch radio much like they would during a normal dispatch call. The embodiment of steps 252-258 demonstrates a means for conferencing parties utilizing disparate access technologies.

Steps 260-262 demonstrate yet another embodiment of method 250 for conferencing three parties with disparate access technologies. In this embodiment, the processor(s) begin with step 252 as described above and proceeds to step 260 where it establishes a two-way full-duplex communication link on a VoIP channel with a second party. The VoIP connection can be established by way of a data channel of the multimode wireless device 302 (e.g., EV/DO channel or 1X channel in a CDMA phone, or GPRS in a GSM phone). The voice channel can operate on a packet-switched real-time transport protocol (RTP) commonly used for supporting VoIP services.

This step can represent a use case in which the second party utilizes, for example, a fixed or portable VoIP handset. Once connected to the second party, the end user of the wireless device 302 can conference the first and second parties by selecting a function of a keypad (e.g., depressing the send button for a mobile device, or conference on a VoIP handset). The signal generated by the keypad can be detected in step 256 by the processor, and in step 262, the processor(s) connect the VoIP voice channel to the circuit-switched voice channel. Since VoIP is a full-duplex service, the end user need not depress any functions of the keypad to maintain the conference. Similarly, the second party need not perform any functions on the VoIP handset to submit voice responses.

From these examples it should be evident to an artisan with ordinary skill in the art that there are innumerable ways to conference or provide dispatching services with multiple parties utilizing disparate or different wireless access technologies according to the present disclosure. For example, the dispatch services of step 254 can be replaced with FRS services to accomplish the same result described earlier. Moreover, the aforementioned embodiments can be supplemented so that more than three-party conferences are possible. This can be accomplished by two or more of the parties in conference adding more parties by way of multimode wireless device 302 capable of processing calls according to the aforementioned embodiments of method 250. From these illustrations, it would be evident to an artisan with ordinary skill in the art that the disclosed and undisclosed embodiments can best be understood from a reading of the claims described below.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mobile wireless subscriber radio, comprising:
a first processor for establishing a first communication link using a first wireless communication protocol;
a second processor for establishing a second communication link using a second wireless communication protocol different from the first wireless communication protocol; and
an interprocessor communication link between the first processor and the second processor enabling communication between the first communication link and the second communication link.

2. The mobile wireless subscriber radio of claim 1, wherein the mobile wireless subscriber radio serves as a dispatcher coupling a first mobile radio using the first wireless communication protocol with a second mobile radio using the second wireless communication protocol.

3. The mobile wireless subscriber radio of claim 1, wherein the first wireless communication protocol is a cellular communication protocol and the second wireless communication protocol is a dispatch radio communication protocol.

4. The mobile wireless subscriber radio of claim 1, wherein the first wireless communication protocol is a cellular communication protocol or a dispatch radio communication protocol and the second wireless communication protocol is a peer-to-peer communication protocol or a talk-around communication protocol or a point-to-point communication protocol.

5. The mobile wireless subscriber radio of claim 1, wherein the first wireless communication protocol is a cellular communication protocol, the second wireless communication protocol is a dispatch radio communication protocol and a third wireless communication protocol is a peer-to-peer communication protocol or a talk-around communication protocol or a point-to-point communication protocol.

6. The mobile wireless subscriber radio of claim 5, wherein the mobile wireless subscriber radio further comprises a third processor for establishing a third communication link using the third wireless communication protocol.

7. The mobile wireless subscriber radio of claim 6, wherein the interprocessor communication link further links the third processor with the first processor and the second processor and enables communication therebetween.

8. The mobile wireless subscriber radio of claim 6, wherein the mobile wireless subscriber radio serves as a dispatcher for a third mobile radio using the third wireless communication protocol and coupling the third mobile radio with a first mobile radio using the first wireless communication protocol and with a second mobile radio using the second wireless communication protocol.

9. The mobile wireless subscriber radio of claim 1, wherein the first wireless communication protocol is a Push-to-Talk over cellular communication protocol and the second wireless communication protocol is a dispatch radio Push-to-Talk communication protocol.

10. The mobile wireless subscriber radio of claim 1, wherein the first wireless communication protocol and the second wireless communication protocol further utilize a wireline communication link.

11. A system for communication across different wireless communication technologies, comprising:
a first base station using a first wireless communication protocol;
at least a second base station using a second wireless communication protocol different from the first wireless communication protocol; and
a multimode wireless mobile device, comprising:
a first processor for establishing a first communication link using the first wireless communication protocol;
at least a second processor for establishing a second communication link using the second wireless communication protocol; and
an interprocessor communication link between the first processor and the second processor enabling communication between a first wireless device on the first communication link and a second wireless device on the second communication link.

12. The system of claim 11, wherein the multimode wireless mobile device serves as a dispatcher coupling the first wireless device using the first wireless communication protocol with the second wireless device using the second wireless communication protocol.

13. The system of claim 11, wherein the first wireless communication protocol is a cellular communication protocol and the second wireless communication protocol is a dispatch radio communication protocol.

14. The system of claim 11, wherein the first wireless communication protocol is a cellular communication protocol or a dispatch radio communication protocol and the second wireless communication protocol is a peer-to-peer communication protocol or a talk-around communication protocol or a point-to-point communication protocol.

15. The system of claim 11, wherein the first wireless communication protocol is a Push-to-Talk over cellular communication protocol and the second wireless communication protocol is a dispatch radio Push-to-Talk communication protocol.

16. The system of claim 11, wherein the first wireless communication protocol and the second wireless communication protocol further utilize a wireline communication link.

17. The system of claim 11, wherein the first wireless communication protocol is a cellular communication protocol, the second wireless communication protocol is a dispatch radio communication protocol and a third wireless communication protocol is a peer-to-peer communication protocol or a talk-around communication protocol or a point-to-point communication protocol.

18. The system of claim 17, wherein the multimode wireless mobile device further comprises a third processor for establishing a third communication link using the third wireless communication protocol and the multimode wireless mobile device serves as a dispatcher for a third mobile radio using the third wireless communication protocol and coupling the third mobile radio with the first wireless device using the first wireless communication protocol and with the second wireless device using the second wireless communication protocol.

19. A mobile wireless subscriber radio, comprising:
a first processor for establishing a first communication link using a first wireless communication protocol;
a second processor for establishing a second communication link using a second wireless communication protocol different from the first wireless communication protocol;
a third processor for establishing a third communication link using a third wireless communication protocol different from the first and second wireless communication protocols;
an interprocessor communication link between the first processor, the second processor, and the third processor enabling communication among the first communication link, the second communication link, and the third communication link.

20. The mobile wireless subscriber radio of claim 19, wherein the mobile wireless subscriber radio serves as a dispatcher for a third mobile radio using the third wireless communication protocol and coupling the third mobile radio with the first wireless device using the first wireless communication protocol and with the second wireless device using the second wireless communication protocol.
